(19) United States
(12) Patent Application Publication
(10) Pub. No.: US 2014/0368917 A1
(43) Pub. Date: Dec. 18, 2014

(54) DIFFRACTION GRATING

(71) Applicant: Hiroyuki Sasai, Kyoto-shi (JP)

(72) Inventor: Hiroyuki Sasai, Kyoto-shi (JP)

(73) Assignee: SHIMADZU CORPORATION, Kyoto-shi, Kyoto (JP)

(21) Appl. No.: 14/377,251

(22) PCT Filed: Feb. 16, 2012
(86) PCT No.: PCT/JP2012/053644

§ 371 Date: Aug. 7, 2014

(51) Int. Cl. G02B 5/18

(52) U.S. Cl. CPC G02B 5/1866
USPC 359/569

(57) ABSTRACT

Provided is a diffraction grating having a surface with a groove-and-ridge structure formed with a preset periodic distance, the groove-and-ridge structure including a plurality of grooves, wherein a concave structure and/or a convex structure extending across at least one of the grooves and having a level difference from the bottom surface of the groove is formed on the surface. In the diffraction grating according to the present invention, the diffracting grooves in the groove-and-ridge structure formed with the preset periodic distance are divided into a plurality of sections. Therefore, even if oil or water contained in air-born dust, the sebum or perspiration of a user, or a similar liquid substance is adhered to the surface of the diffraction grating, the oil or the like will not spread over an area other than the section to which it has adhered. Thus, a decrease in the diffraction efficiency is prevented.

### TECHNICAL FIELD

The present invention relates to a diffraction grating. More specifically, it relates to a diffraction grating having a specifically devised structure for preventing a decrease in the diffraction efficiency due to contamination of the diffracting surface.

### BACKGROUND ART

A diffraction grating is an optical element for separating white light, i.e. the mixture of various wavelengths of light, into wavelength components. Such an element is used in a spectroscope or similar optical instruments. Diffraction gratings are roughly divided into two types: reflection grating, which separates incident light into wavelength components by reflecting the light on its surface, and transmission grating, which allows incident light to penetrate into and pass through its body to produce a spectrum of light separated into wavelength components. In any of the reflection and transmission types, the grating has a surface with a groove-and-ridge structure cyclically formed with a preset periodic distance corresponding to the wavelength range to be used (for example, see Patent Literature 1).

### CITATION LIST

### Patent Literature

Patent Literature 1: JP 2004-198461 A

### SUMMARY OF INVENTION

### Technical Problem

Normally, the surface of a diffraction grating which is set in a spectroscope is exposed to the air. Therefore, various substances (e.g. oil or water) contained in the air-born dust adhere to the surface of the diffraction grating. Furthermore, in the process of setting the diffraction grating in the spectroscope, the sebum or perspiration from the user's fingers may adhere to the surface of the diffraction grating. Such a liquid substance 4 containing oil and/or the like (see FIG. 1A, where the upper drawing is a plan view and the lower drawing is a front view) which has adhered to the surface of the diffraction grating 21 and entered the grooves 22 on the surface of the diffraction grating gradually spreads and fills the grooves 22 (see FIG. 1B), which lowers the diffraction efficiency of the grating. FIG. 2 is a photograph of the surface of a diffraction grating with diffracting grooves ruled on it in the vertical direction, which shows an oil or similar contaminant widely spread along the diffracting grooves.

The problem to be solved by the present invention is to provide a diffraction grating whose diffraction efficiency will not be significantly lowered even if oil or water contained in air-born dust, the sebum or perspiration of a user, or similar liquid substance is adhered to the surface of the diffraction grating on which the groove-and-ridge structure is formed.

### Solution to Problem

The present invention aimed at solving the previously described problem is a diffraction grating having a surface with a groove-and-ridge structure formed with a preset periodic distance, the groove-and-ridge structure including a plurality of grooves, and the diffraction grating being characterized in that a concave structure and/or a convex structure cutting across at least one of the grooves and having a level difference from the bottom of the groove is formed on the surface.

In the diffraction grating according to the present invention, among the grooves formed on the surface of the diffraction grating with a preset periodic distance, each groove which is cut across the concave or convex structure having a level difference from the bottom surface of the groove is divided into a plurality of sections by the concave or convex structure. Therefore, even if an oil or similar liquid substance is adhered to the surface, the adhered oil or the like cannot spread from one section to another. Specifically, in the case where the concave structure is provided, the oil or the like spreading from the section to which it has adhered enters the concave structure and cannot reach other sections. In the case where the convex structure is provided, the oil or the like spreading from the section to which it has adhered is blocked by the convex structure and cannot reach other sections. Therefore, the situation in which the adhered oil or the like spreads over the entire groove and significantly lowers the diffraction efficiency will not occur as in the conventional case.

Users often hold a diffraction grating with their fingers at the edges of the grating. Accordingly, in order to prevent the thereby adhered sebum or perspiration of the user from spreading into the central region of the surface of the diffraction grating, the concave structure or the convex structure should preferably be provided in a marginal region of the surface of the diffraction grating. The marginal region means outside the central region on the surface of the diffraction grating onto which a beam of light is irradiated when the grating is used in a spectroscope. Given the fact that the skin of fingertips holding a spectroscope protrudes inwards by approximately 1 mm, the concave structure or the convex structure only needs to be located at approximately 2 mm inside from the edge of the surface of the spectroscope (or up to approximately 5 mm with some allowance). This design makes no influence on the cyclic ridge-and-groove structure in the central region of the surface of the diffraction grating which serves as the primary passage for light. Therefore, no decrease in the diffraction efficiency occurs due to the provision of the concave or convex structure.

### Advantages Effects of the Invention

In the diffraction grating according to the present invention, the ridge-and-groove structure formed on the surface of the diffraction grating with a preset periodic distance is divided into a plurality of sections. Therefore, even if oil or water contained in air-born dust, the sebum or perspiration of a user, or a similar liquid substance is adhered to the surface of the diffraction grating on which the groove-and-ridge structure is formed, the oil or the like will not spread over an area other than the section to which it has adhered. Therefore, the diffraction efficiency will not significantly decrease as in the conventional case.

### BRIEF DESCRIPTION OF DRAWINGS

FIGS. 1A and 1B illustrate how an oil or similar contaminant spreads on a surface of a conventional diffraction grating.

FIG. 2 is a photograph showing a surface of a diffraction grating with a contaminant spread on the diffracting surface.

FIG. 3 illustrates one embodiment of the diffraction grating according to the present invention.

FIGS. 4A and 4B illustrate how an oil or similar contaminant spreads on a surface of the diffraction grating of the aforementioned embodiment.

FIG. 5 illustrates another embodiment of the diffraction grating according to the present invention.

FIG. 6 illustrates still another embodiment of the diffraction grating according to the present invention.

### DESCRIPTION OF EMBODIMENTS

One embodiment of the diffraction grating according to the present invention is hereinafter described with reference to the drawings.

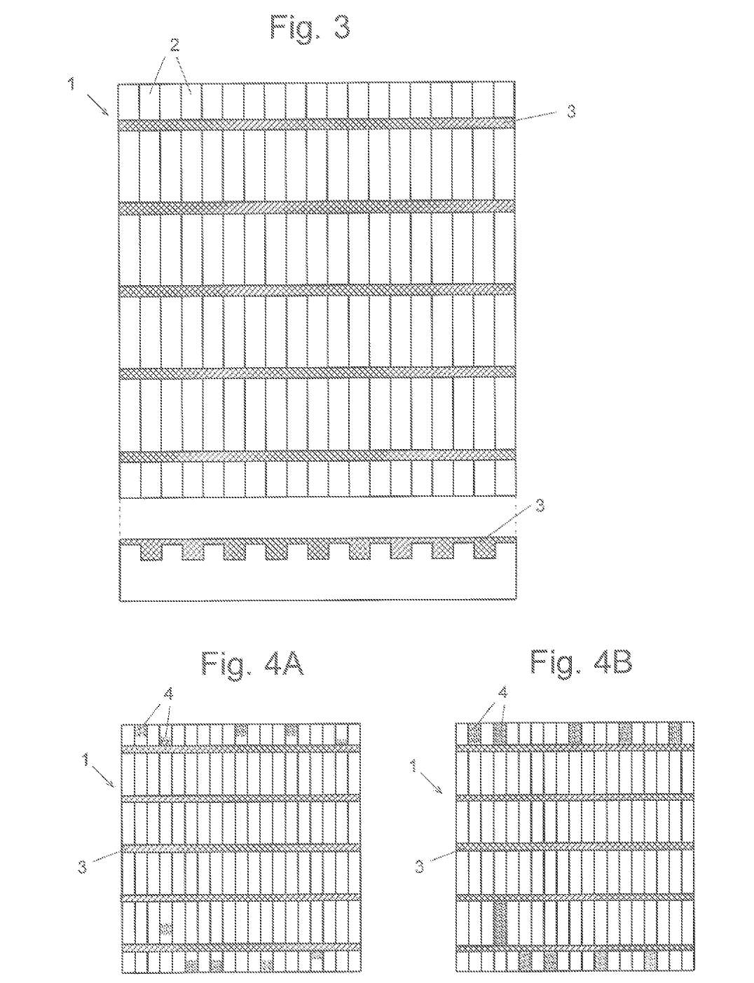

FIG. 3 shows a plan view (upper drawing) and a front view (lower drawing) of the diffraction grating 1 of the present embodiment. The diffraction grating 1 of the present embodiment is a laminar grating having a surface with cyclic rectangular grooves 2 forming the ridge-and-groove structure. Five convex structures 3 orthogonal to the rectangular grooves 2 are provided at regular intervals. In the diffraction grating 1 of the present embodiment, the level of the top of the convex structures 3 is slightly higher than that of the ridges of the ridge-and-groove structure cyclically formed on the surface of the diffraction grating. Since the convex structures 3 only need to divide each rectangular groove 2 into a plurality of sections, the top of the convex structures 3 may be lower than that of the ridges of the cyclic groove-and-ridge structure as long as it is higher than the bottom surface of the rectangular groove 2.

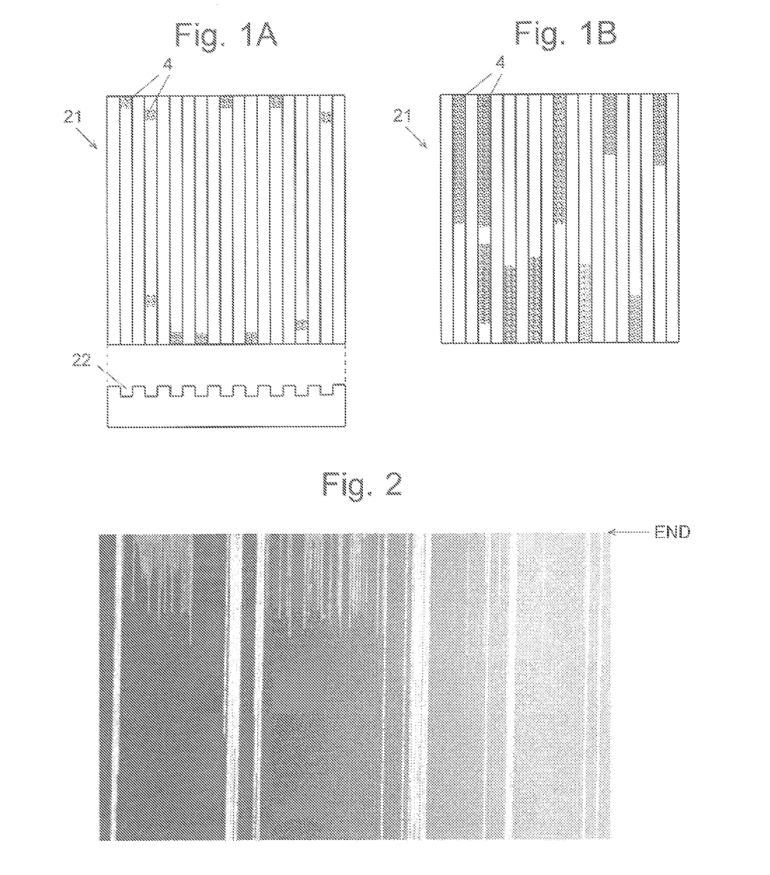

The spreading of an oil or similar liquid substance 4 which has adhered to the diffracting surface of the diffraction grating 1 of the present embodiment and entered the rectangular grooves 2 is hereinafter described with reference to FIGS. 4A and 4B. FIG. 4A shows the diffraction grating 1 of the present embodiment with the oil or similar liquid substance 4 adhered to the same locations as in FIG. 1A. As already explained, in the case of the conventional diffraction grating 11, the oil or similar liquid substance 4 which has entered the diffraction grooves 22 gradually spreads over wide areas along the diffraction grooves 22 (see FIG. 1B) and significantly lowers the diffraction efficiency. By contrast, in the case of the diffraction grating 1 of the present embodiment, since the rectangular grooves 2 are divided into a plurality of sections by the convex structures 3, the spreading of the oil or similar liquid substance 4 is limited within the sections to which the liquid substance has adhered, as shown in FIG. 4, and there is no influence on the neighboring sections. Therefore, the diffraction efficiency will not be significantly lowered as in the case of the conventional diffraction grating 11.

It is also possible to divide the rectangular grooves 2 into a plurality of sections by providing concave structures deeper than the rectangular grooves 2. In this case, when the adhered oil or similar liquid substance 4 reaches an end of one section, the substance enters the concave structure and cannot spread over the neighboring section. Thus, the decrease in the diffraction efficiency can be prevented whichever of the convex and concave structures is used to divide the rectangular grooves 2 into multiple sections.

At the locations where the convex or concave structures are provided, the cyclic pattern of the groove-and-ridge structure is lost and the desired diffraction of light does not occur. Therefore, the intensity of the diffracted light will be too low if the convex or concave structures are provided in excessive numbers or with an excessive size. Accordingly, it is preferable to control the number and size of the convex or concave structures so that the total area of those structures will be no greater than 5% of the area of the surface of the diffraction grating on which the cyclic groove-and-ridge structure is formed.

Normally, when incident light is separated into wavelengths by means of a diffraction grating, an intense light is irradiated onto the central region of the surface of the diffraction grating. Meanwhile, the adhesion of the sebum or perspiration of the user is likely to occur when the user holds the diffraction grating with its end. Accordingly, it is preferable to provide the convex or concave structures in the marginal region of the surface of the diffraction grating and not in its central region. Given the fact that the skin of fingertips holding a spectroscope protrudes inwards by approximately 1 mm, the spreading of the sebum or perspiration of the user into the central region can be adequately prevented by providing the concave or convex structures at approximately 5 mm inside from the edge of the surface of the diffraction grating. If it is certain that users will carefully handle the diffraction grating, the convex or concave structures may be located at approximately 1 mm from the edge. By such a design, the oil or similar liquid substance which adheres to the diffraction grating when the user holds the grating can be prevented from spreading into the central region, without causing a decrease in the diffraction efficiency due to the creation of the convex or concave structures.

FIG. 5 shows one example; the upper drawing is a plan view of the diffraction grating 11 while the lower drawing is a front view (left) and a C-C′ sectional view (right) of the same grating. The diffraction grating of the present embodiment is a 5 cm×5 cm laminar grating having two concave structures 5 orthogonal to the rectangular grooves 2 provided at a distance of 5 mm from each end of the surface of the diffraction grating. The concave structures 5 are deeper than the bottom surface of the rectangular grooves 12. As already explained, if the concave structures 5 are provided, any liquid substance which adheres to the ends of the surface of the diffraction grating of the diffraction grating while being held by a user enters the concave structures 5 and is thereby prevented from spreading into the central region of the surface of the diffraction grating, so that the diffraction efficiency will not decrease.

In any of the previous embodiments, the convex structures 3 or the concave structures 5 formed orthogonally to the rectangular grooves. However, those structures do not always need to be orthogonal to the grooves. FIG. 6 shows another possible example, in which the rectangular grooves 2 are divided into a plurality of sections by providing convex structures 6 each of which obliquely extends with respect to the rectangular grooves 2. It is also possible to give the convex or concave structures a curved form (e.g. a circular form).

The configuration of the present invention can be applied to any diffraction grating having a surface on which a groove-and-ridge structure is formed with a preset periodic distance. For example, the present invention can also be applied to a diffraction grating having saw-tooth grooves or sinusoidal grooves, other than a diffraction grating having a cyclic groove-and-ridge structure formed by rectangular grooves as in the previous embodiments. In those cases, the saw-tooth or sinusoidal grooves should be divided into a plurality of sections by providing a convex structure higher than the bottom of the grooves or a concave structure lower than the bottom of the grooves.

The present invention can be applied to both reflection grating and transmission grating.

The present invention is not limited to a diffraction grating whose surface having the groove-and-ridge structure formed with a preset periodic distance is flat; it can also be applied to a diffraction grating having a concave or convex surface.

### REFERENCE SIGNS LIST

1, 11, 21 . . . Diffraction Grating
2, 12, 22 . . . Groove (Rectangular Groove)
3, 6 . . . Convex Structure
4, 14 . . . Liquid Substance
5 . . . Concave Structure

1. A diffraction grating having a surface with a groove-and-ridge structure formed with a preset periodic distance, the groove-and-ridge structure including a plurality of grooves, and the diffraction grating being characterized in that a concave structure and/or a convex structure cutting across at least one of the grooves and having a level difference from a bottom of the groove is formed on the surface.

2. The diffraction grating according to claim 1, wherein the concave structure and/or the convex structure is provided in a marginal region of the surface of the diffraction grating.

3. The diffraction grating according to claim 1, wherein a total area of the concave structure and/or the convex structure is no greater than 5% of an area of the surface of the diffraction grating on which the cyclic groove-and-ridge structure is formed.

4. The diffraction grating according to claim 2, wherein a total area of the concave structure and/or the convex structure is no greater than 5% of an area of the surface of the diffraction grating on which the cyclic groove-and-ridge structure is formed.
